(19) United States
(12) Patent Application Publication
(10) Pub. No.: US 2004/0076141 A1
(43) Pub. Date: Apr. 22, 2004

(54) Digital closed network constructed from a telephone exchange and a key telephone system and signal transmission method of the digital closed network

(76) Inventor: Heng-Chien Chen, Taipei (TW)

Correspondence Address: DELLETT AND WALTERS, 310 S.W. FOURTH AVENUE, SUITE 1101, PORTLAND, OR, 97204, US

(21) Appl. No.: 10/277,547

(22) Filed: Oct. 21, 2002

(51) Int. Cl. H04L 12/64; H04L 12/66

(52) U.S. Cl. 370/352; 370/356; 370/401; 370/465

(57) ABSTRACT

A digital closed network is constructed from a telephone exchange (10) and a plurality of telephones (20), wherein each telephone (20) is further for connection to a network device (30), such as a computer, hub, network printer etc. Over the closed network, data and video information are transmitted in the form of packets. Moreover, communicating voice signals are converted to the form of voice packets by the telephones (20), whereby the superior transmission quality is obtained. Furthermore, the transmission priority among the voice, data and video packets is controllable in the closed network, thus when there is a great quantity of packets being transmitted, the voice packets still possess high real time transmissions.

### BACKGROUND OF THE INVENTION

1. Field of the Invention

The invention is related to a digital closed network constructed from a telephone exchange and a key telephone system (KTS) and the signal transmission method of the digital closed network, and more particularly to a digital closed network that provides the functions of voice, data and voice signal transmission and retains the superior communication quality.

2. Description of the Prior Art

Since the VoIP (Voice over Internet Protocol) has the advantage of lower communication cost than conventional telephone system and has the ability to integrate data, more and more enterprises employ the VoIP as the communicating means. Based on the established VoIP, the enterprise can simultaneously perform the voice, data and video signal transmission over the single IP platform. Therefore, not only is the network management process simplified, but also the entire cost is reduced. With reference to FIG. 4, a local area network (LAN) integrated with telephone exchange system is mainly composed of hubs (70), computers (71) and a telephone exchange (72), wherein the hub (70) is further connected with extensions (73). As shown in FIG. 5, a hub (70) is connected to a plurality of computers (71), wherein some specific computers (71) are respectively connected with the telephone exchange (72) and the extension (73).

In the network architecture mentioned above, the extension (73) only occupies a part of bandwidth (for example, 4K) for voice signal transmission. However, whether the conventional IP network or the LAN, the data signal (data packet) is the main transmission subject. The objective of the network architecture design still focuses on the improvement of the reliability, i.e. to make the data packet have the highest transmission priority during the transmission process. In such a condition, when a great amount of data is transmitting among these computers (71), the serious problems of voice signal transmission delay and jitter accordingly arise. However, for voice signal, the most essential requirement is immediate transmission (i.e. the real time transmission). Therefore, the bad transmission quality is obvious.

Since the conventional network configuration is unable to solve the delay problem of signal transmitting, one temporary way to improve the voice signal transmission quality and to alleviate the problem is by utilizing the broad bandwidth. However, when a great quantity of data is being transmitted, these data still cause delay to the voices and such a temporary solution way is unable to completely overcome the problem.

To overcome the shortcomings, a digital closed network in accordance with the present invention obviates or mitigates the aforementioned problems.

### SUMMARY OF THE INVENTION

The primary objective of the present invention is to provide a digital closed network that is constructed by exchange, key telephone system (KTS) and computers to transmit the voice, data and video signals, and still retains the superior voice transmission quality.

To achieve the objective, the transmission method for the network of the present invention employs a telephone as the node for connection to network devices, such as a personal computer or a telephone exchange, to form a closed network. The telephone not only processes the data and video packets, but also has the signal converting ability to convert the voice signals to the form of voice packets. Since the voice signals are transmitted in the form of voice packets over the network, the influence caused from the great quantity of data packets and video packets is able to eliminate and the transmission quality is improved.

Said telephone further possesses the priority setting function to decide the transmission priority between the voice packets and other types of packets. When the voice packets are set with the highest priority, the real time transmission requirement for voice packet is able to be achieved, meanwhile the data and video packets still retain good reliability.

The network architecture of the present invention comprises:

at least one private branch exchange (PBX) connected with a plurality of trunk lines or leased lines, wherein a packet processing unit for converting voices signals to the form of voice packets is disposed inside the PBX;

a plurality of telephones connected to the PBX so as to construct a closed network architecture for voice, data and video transmitting; and

a plurality of network devices, such as computers, network printers, hubs etc. respectively connected to the telephones.

Each telephone further comprises:

a controller with two-way converting function, wherein the controller is able to convert voice signals to the form of voice packets, and is able to restore the voice packets to the voice signals;

a handset for receiving voice signals from a user and then transmit the received signals to the controller, or broadcasting voices signals from the controller;

a first network connecting interface connecting between the controller and the network device; and

a second network connecting interface connecting between the controller and the PBX.

In the foregoing network architecture, the voice, data or video packets are able to be transmitted among the network devices through the plurality of telephones. In addition, those packets are able to be transmitted to an external network through the PBX. Since the voice is transmitted in the form of voice packets, the requirements of real time voice transmission and the high reliability data/video packet transmission are both satisfied.

### BRIEF DESCRIPTION OF THE DRAWINGS

FIG. 1 is a function block diagram of a digital closed network configuration in accordance with the present invention;

FIGS. 2A-2C are schematic topologies showing a net work-PBX (private branch exchange) connected to a plurality of telephones in accordance with the present invention;

FIG. 3 is a schematic view showing a preferred embodiment of a closed network in accordance with the present invention;

FIG. 4 is a function block diagram of a conventional network configuration; and

FIG. 5 is a further function block diagram of a conventional network configuration.

### DETAILED DESCRIPTION OF THE PREFERRED EMBODIMENT

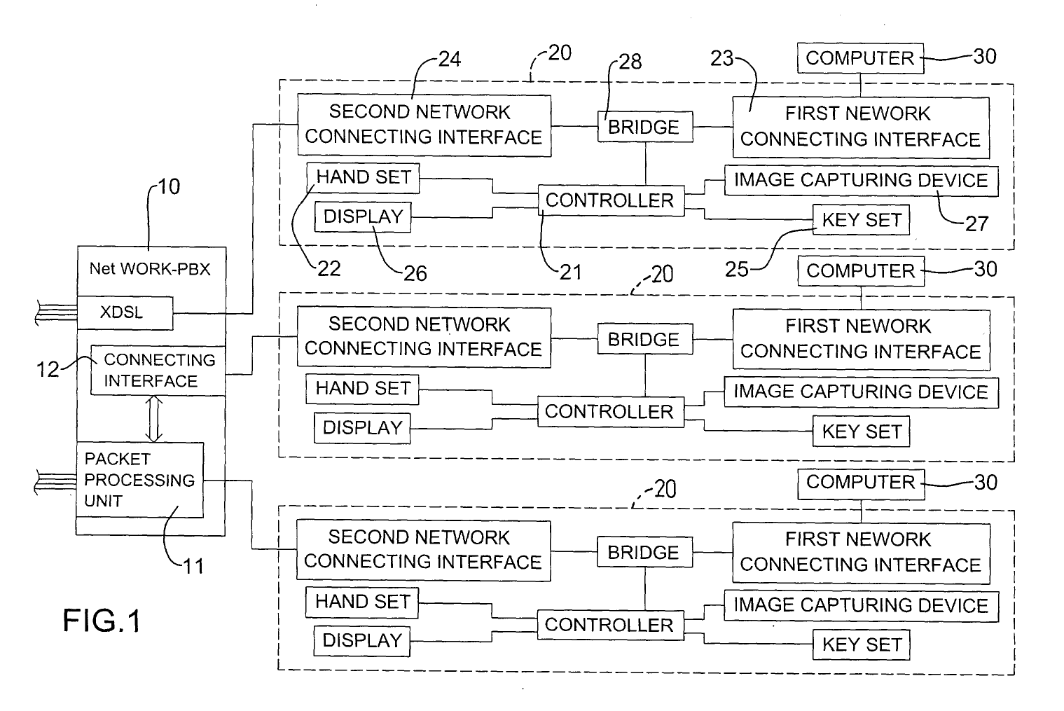

With reference to FIG. 1, a closed network in accordance with the present invention comprises at least one telephone exchange (private branch exchange, PBX)(10), a key telephone system (KTS) composed of a plurality of telephones (20) and network devices (30).

The PBX (10) connected with a plurality of trunk lines or leased lines (for example XDSL) has a packet processing unit (11) for two-way converting, i.e. to convert the external voices signals to the form of voice packets, or to restore the voice packets to the voice signals.

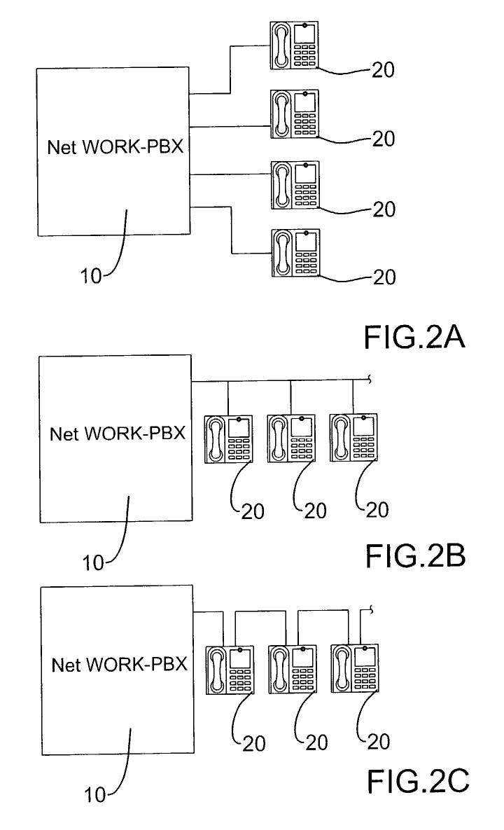

The plurality of telephones (20) is able to connect to the PBX (10) with different topologies (as shown in FIGS. 2A-2C) so as to construct a closed network for voice, data and video transmitting.

The network devices (30), such as personal computers (the example in this embodiment), network printers, hubs or facsimile machines etc., are respectively connected to the telephones (20) for communicating with the closed network.

Each telephone (20) further comprises:

a controller (21) with the two-way converting function, wherein the controller (21) is able to convert voice signals to the form of voice packets, and is able to restore the voice packets to the voice signals;

a handset (22) to receive voice signals from a user and then transmit to the controller (21), or to broadcast voices signals output from the controller (21);

a first network connecting interface (23) connecting between the controller (21) and the network device (30), wherein the first network connecting interface (23) is for connection with a network interface card installed in the network device (30);

a second network connecting interface (24) connecting between the controller (21) and the PBX(10);

a key set (25) connected to the input terminals of the controller (21) for the use of dialing or parameters setting;

a display (26) connected to the output terminal of the controller (21) to display messages or video images; and

an image capture device (27), such as a CCD (Charge-Coupled Device) camera, connected to the input terminal of the controller (21) for the use of image capture, wherein the captured images are then processed to become the form of video packets by the controller (21) for further transmission.

Each telephone (20) further includes a bridge (28) linked between the first network connecting interface (23) and the second network connecting interface (24) to perform the transmission flow control of the closed network.

The PBX (10) further has a connecting interface (12) that not only connects to the packet processing unit (11), but also connects with the second network connecting interface (24) of each telephone (20).

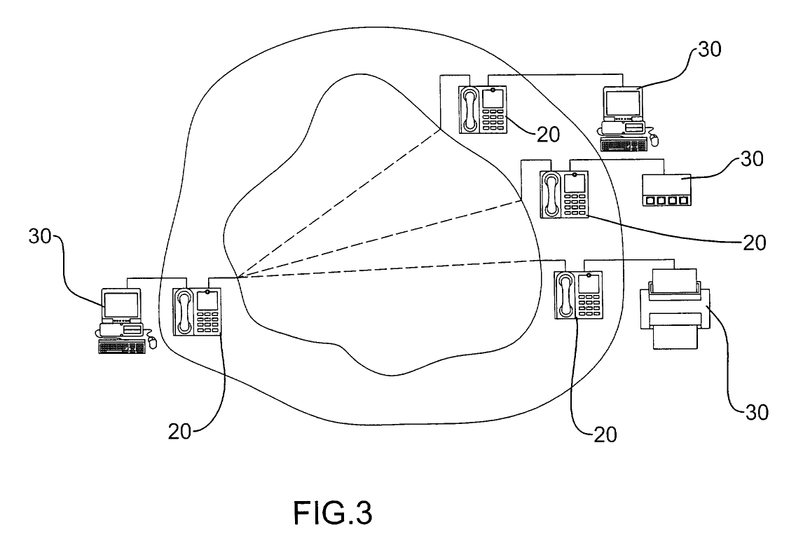

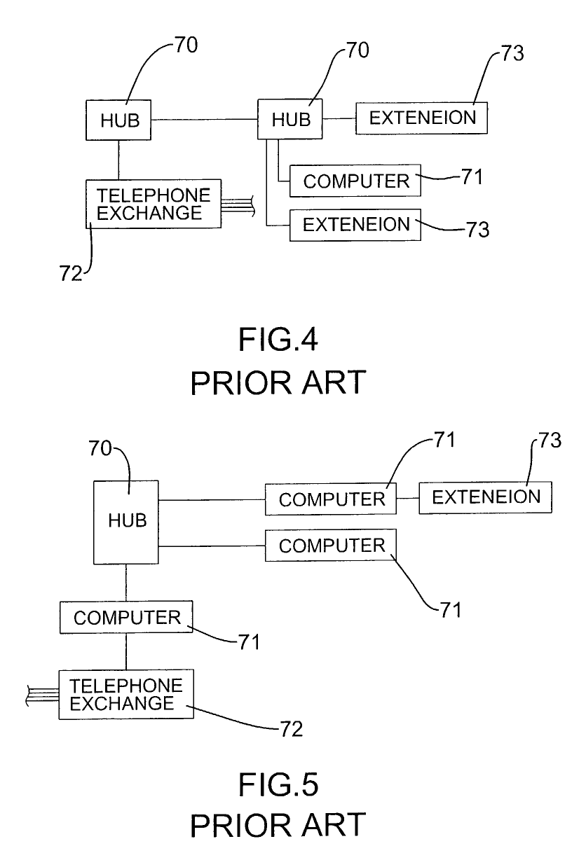

From the foregoing description of the network architecture, the plurality of telephones (20) not only constructs the closed network in company with the PBX (10), but each telephone (20) is also used as an intermediary node that allows the personal computer, hub or network printer etc. to communicate with the closed network (as shown in Fig. 3).

One especial point that needs to be noted is when the voice signal is communicating over the closed network, the network will provide superior transmission quality. For example, if one telephone (20) is used as a transmitter (the voice source), the input voice from the handset (22) is converted to the form of voice packets by the controller (21) and then transmitted over the closed network. After another telephone (20), which acts as-a voice receiver, receives and converts the voice packet to voice signal by the controller (2 1), the voice signal is then broadcasted via the handset (22). Since the voice is transmitted in the form of voice packets, the problems of transmission delay and jitter are accordingly overcome. Moreover, by controlling the controller (21) and the bridge (28) to properly set the transmission priority among the voice packets, data packets and the video packets, the transmission quality is able to be further improved. In other words, because of the controllable transmission flow in the closed network, the real time voice transmission is assured.

In conclusion, the particular network architecture of the present invention together with the telephone system having packet conversion ability and bridge function collectively provide an immediate voice transmission, wherein the problems of delay and jitter are avoided. In addition, the network architecture of the present invention also meets the data transmission protocol (IEEE 802.3) to ensure that the data/video packets are correctly transmitted among all nodes of the network. In other words, the present invention still retains the high reliability for data/video transmission.

The invention may be varied in many ways by a skilled person in the art. Such variations are not to be regarded as a departure from the spirit and scope of the invention, and all such modifications are intended to be included within the scope of the following claims.

What is claimed is:

1. A signal transmission method of a closed network constructed from at least one telephone exchange (10) and a key telephone system that is composed of a plurality of telephones (20), the method comprising the steps of:
connecting each telephone (20) to the telephone exchange (10);
employing each telephone (20) as a node for connection to a network device (30) so as to form the closed network for voice, data and video transmission; and
converting voices received from a first one of the plurality of telephones (20) to the form of voice packets;
transmitting the voice packets to a second one of the plurality of telephones (20), wherein the second one of the plurality of telephones (20) converts and broadcasts the voice packets to the form of voice signals.

2. The method as claimed in claim 1, the method further comprising a step of transmission priority setting, wherein the voice packets are set to have the highest transmission priority by the setting of the telephone (20).

3. The method as claimed in claim 1, the telephone exchange (10) further having the function of two-way converting, wherein the telephone exchange (20) is able to convert the external voices signals to the form of voice packets, or to restore the voice packets to the voice signals.

4. A digital closed network comprising:
at least one telephone exchange (10) connected with a plurality of trunk lines/leased lines, wherein the telephone exchange (10) has a voice packet converting and restoring function;
multiple telephones (20) connected to the telephone exchange (10) to form the closed network, whereby voice, data and video are able to transmitted over the closed network; and
multiple network devices (30), wherein each network device (30) is connected to one of the multiple telephones to communicate with the telephone exchange (10).

5. The digital closed network as claimed in claim 4, wherein each telephone (20) further comprises:
a controller (21) with the two-way converting function, wherein the controller (21) is able to convert voice signals to the form of voice packets, and is able to restore the voice packets to the voice signals;
a handset (22) transmitting received voice signals to the controller (21), wherein the handset (22) is able to broadcast voice signals output from the controller (21);
a first network connecting interface (23) connecting between the controller (21) and one of the network device (30); and
a second network connecting interface (24) connecting between the controller (21) and the telephone exchange (10).

6. The digital closed network as claimed in claim 5, wherein the telephone exchange comprises a packet processing unit (11) disposed between the plurality of trunk lines and a connecting interface (12), wherein the connecting interface (12) is for connection with the second network connecting interface (24).

7. The digital closed network as claimed in claim 5, wherein the first network connecting interface (24) is connected to the network device (30) through a network interface card installed in the network device (30).

8. The digital closed network as claimed in claim 5, wherein each telephone (20) further comprises a bridge (28) connected between a first network connecting interface (23) and the second network connecting interface (24) to control transmission flow.

9. The digital closed network as claimed in claim 5, wherein the controller (21) further connects to display (26), a key set (25) and an image capturing device (27).

10. The digital closed network as claimed in claim 4, wherein the network devices (30) are chosen from a group consisting of a computer, a hub, a network printer or a facsimile machine.
